(19) United States
(12) Patent Application Publication
(10) Pub. No.: US 2015/0352802 A1
(43) Pub. Date: Dec. 10, 2015

(54) PROTECTIVE PACKAGING WORK STATION

(71) Applicant: Storopack, Inc., Cincinnati, OH (US)

(72) Inventor: William Matthew Lawson, Franklin, OH (US)

(21) Appl. No.: 14/734,255

(22) Filed: Jun. 9, 2015

Related U.S. Application Data
(60) Provisional application No. 62/009,716, filed on Jun. 9, 2014.

(51) Int. Cl. B31F 1/20; A47B 83/04; B65B 67/00; A47B 87/00

(52) U.S. Cl. CPC B31F 1/205; A47B 87/002; A47B 83/04; B65B 67/00; A47B 2087/004

(57) ABSTRACT

A protective packaging work station comprises a first elongated work surface, a second elongated work surface spaced transversely from the first elongated work surface, a machine that makes protective packaging cushions positioned at corresponding ends of the work surfaces, and an elongated slide positioned between the work surfaces that directs cushions from the machine longitudinally along the work surfaces and transversely between the work surfaces as the machine makes and dispenses the cushions.

### RELATED APPLICATIONS

This application claims the priority benefit of U.S. Provisional Patent Application No. 62/009,716 filed Jun. 9, 2014, which is hereby incorporated by reference herein as if fully set forth in its entirety.

### FIELD OF THE INVENTION

This invention relates generally to protective packaging, and more particularly to protective packaging work stations.

### BACKGROUND OF THE INVENTION

It is known to provide protective packaging material to surround an item in a box that is to be shipped in the box. The protective packaging material is placed between the walls of the box and the item shipped, and the box is then closed by taping the box flaps closed. Examples of such protective packaging are strips of crumpled paper in the form of paper cushions, air filled plastic bags in the form of air pillows or cushions, and foam “peanuts”.

Paper cushions and air cushions are typically made on site with a machine for that purpose. In either instance a packer receives the cushions from the machine, and then places them into the box supported on a work surface.

One example of a known protective packaging work station has an elongated work surface, i.e. table or conveyor, and a paper cushion machine at one end of the work surface. The machine can be positioned such that the cushion output of the machine is either above the work surface or at about the same level of the work surface. An elongated slide or tube extends from the cushion machine generally parallel to the longitudinal extent of the work surface. Paper cushions are fed along the slide or tube and are removed from the slide, or from the tube through an opening in the tube, by the packer, and placed into the box.

The human factors of the protective packaging work station are important, and improvements thereto are continually desired. In addition, in most any packaging environment, work space comes at a premium, and so to the extent that the footprint of protective packaging work stations can be shrunk without compromising human factors, that, too, is desirable.

Accordingly, further improvements in protective packaging work stations are desired.

### SUMMARY OF THE INVENTION

In one aspect, a protective packaging work station comprises a first elongated work surface, a second elongated work surface spaced transversely from the first elongated work surface, a machine that makes protective packaging cushions positioned at corresponding ends of the work surfaces, and an elongated slide positioned between the work surfaces that receives cushions from the machine and directs the cushions longitudinally along the work surfaces and transversely between the work surfaces as the machine makes and dispenses the cushions.

The machine can be configured to make paper cushions. The machine can comprise a supply of an elongated web of paper tube, a core, a feed mechanism for feeding the paper tube over the core, and a crumpling mechanism, downstream of the feed mechanism, for crumpling the paper tube around a circumference thereof.

The machine can be configured to crumple an elongated paper tube longitudinally and radially so as to impart creases which are generally transverse to the longitudinal axis of the tube and which extend circumferentially around the tube, the crumpled paper tube having a generally annular cross-section with an outer diameter and an inner diameter defining a longitudinal bore of the crumpled paper tube, the crumpled paper tube having a resilience greater than that of the elongated paper tube in an uncrumpled state.

The work surfaces can be work tables. The work station can further include a shelf positioned above the work tables and centered over the slide. The work station can include a shelf positioned below each work table.

The slide can be continuously open from above along a length thereof. Or, the slide can be a tube with discrete openings therein along a length thereof.

The work station can include a plurality of photo eyes positioned along the slide. The photo eyes can be configured to communicate with the machine such that when uncovered as by a packer removing a cushion from thereover, the photo eyes command the machine to make more cushions until covered again.

The slide can be either supported by the work surfaces, or free standing independent of the work surfaces.

Each work surface preferably has a transverse dimension that does not prevent a packer from reaching across the work surface to remove a cushion from the slide.

In another aspect, a protective packaging work station comprises a first elongated work table supported by legs, a second elongated work table supported by legs and spaced transversely from the first elongated work table, a machine for making protective packaging cushions positioned at corresponding ends of the work tables and comprising a supply of an elongated web of paper tube, a core, a feed mechanism for feeding the paper tube over the core, and a crumpling mechanism, downstream of the feed mechanism, for crumpling the paper tube around a circumference thereof, and an elongated slide supported by the work tables that receives cushions from the machine and directs the cushions longitudinally along the work tables and transversely between the work tables as the machine makes and dispenses the cushions.

The work station can further include a controller and a plurality of photo eyes positioned along the slide. The photo eyes can be configured to communicate with the machine via the controller such that when uncovered as by a packer removing a cushion from thereover, the controller commands the machine to make more cushions until covered again.

In another aspect, a protective packaging work station comprising a first elongated work table supported by legs, a second elongated work table supported by legs and spaced transversely from the first elongated work table, a machine for making protective packaging cushions positioned at corresponding ends of the work tables and comprising a supply of an elongated web of paper tube, a core, a feed mechanism for feeding the paper tube over the core, and a crumpling mechanism, downstream of the feed mechanism, for crumpling the paper tube around a circumference thereof, and an elongated and free standing slide positioned between the work tables that receives cushions from the machine and directs the cushions longitudinally along the work tables and transversely between the work tables as the machine makes and dispenses the cushions.

The slide can be supported on a pair of vertically adjustable legs.

The accompanying drawings, which are incorporated in and constitute a part of this specification, illustrate embodiments of the invention and, together with the summary of the invention given above, and the detailed description of the drawings given below, serve to explain the principles of the present invention.

### BRIEF DESCRIPTION OF THE DRAWINGS

FIG. 1 is a perspective view of a protective packaging work station according to the principles of the present invention.

FIG. 2 is an end view thereof.

FIG. 3 is a front view thereof.

FIG. 4 is a diagrammatic side view of one type of paper cushion machine that can be employed in the protective packaging work station of FIGS. 1-3.

FIG. 5 is a perspective view of another embodiment of a slide.

FIG. 6 is a front view of the slide of FIG. 5.

### DETAILED DESCRIPTION OF THE DRAWINGS

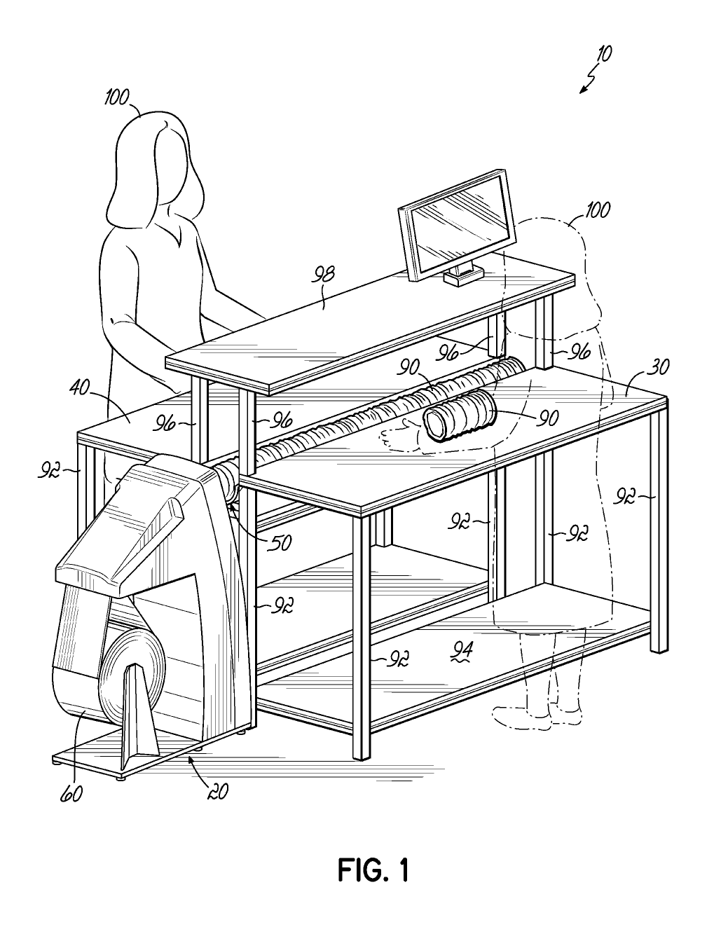

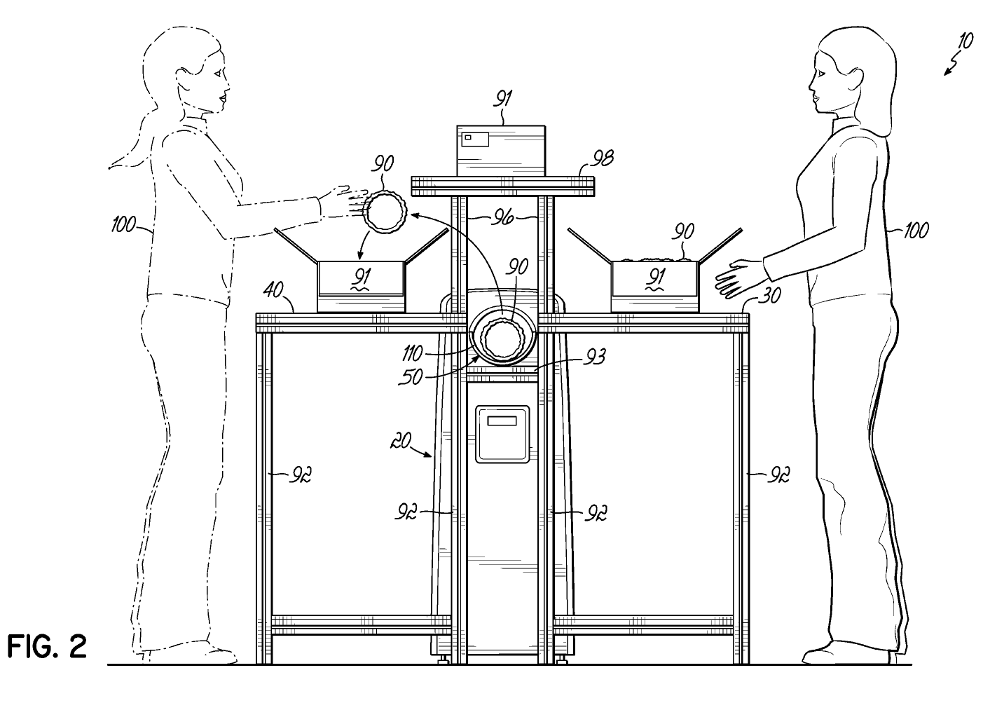

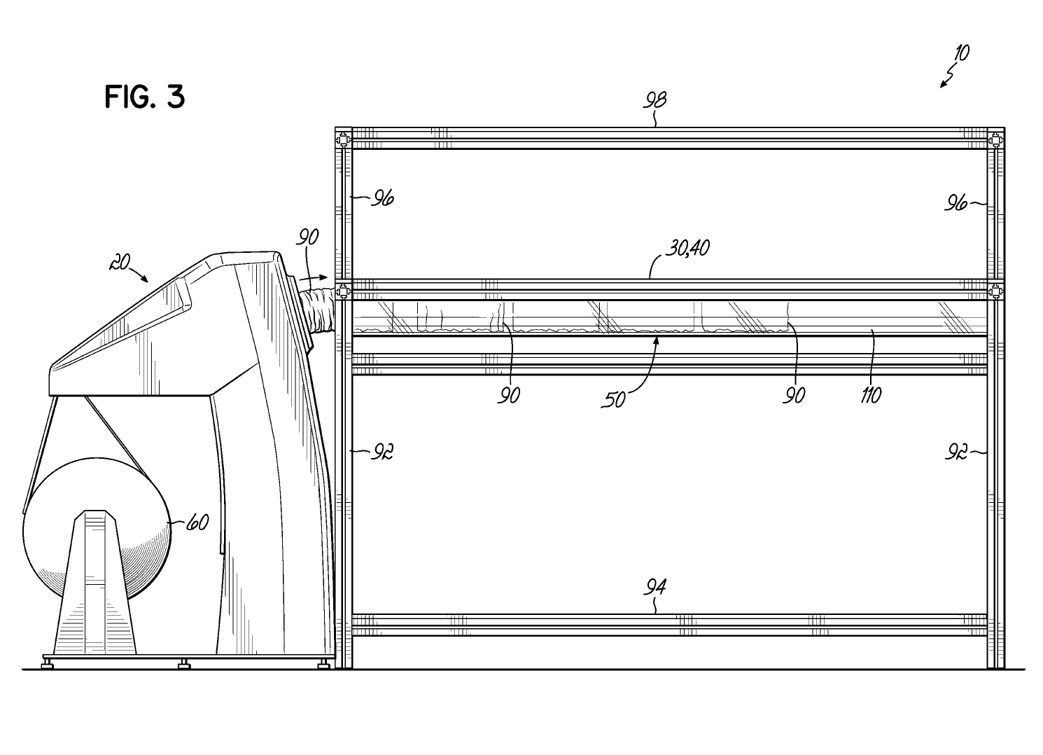

Referring first to FIGS. 1-3, a protective packaging work station 10 according to the principles of the present invention is illustrated. The work station 10 comprises a cushion machine 20, e.g. paper cushion machine or air cushion machine, a pair of elongated work surfaces 30, 40, and a slide 50.

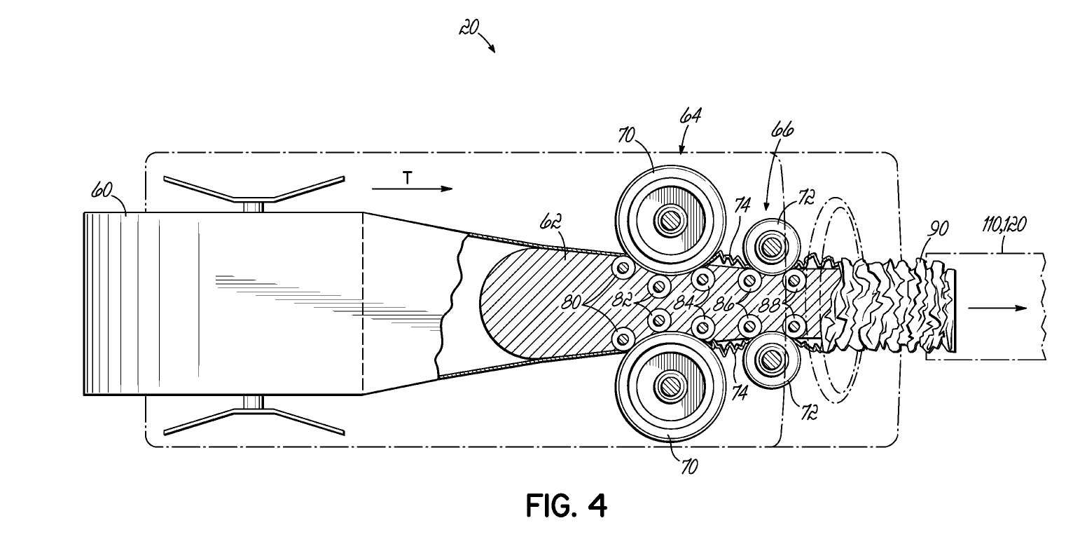

Referring to FIG. 4, one type of cushion machine 20 that can be utilized in the practice of the present invention is a paper cushion machine having a supply roll of an elongated web of paper tube 60, a core 62, a feed mechanism 64 for feeding the paper tube 60 over the core 62, and a crumpling mechanism 66, downstream of the feed mechanism 64, for crumpling the paper tube 60 around a circumference thereof. More particularly, paper tube 60 is drawn onto core 62 by two pairs of driven rollers 70. One pair of rollers 70 can be seen; a further pair is located perpendicularly in front of and behind the plane of FIG. 4, in the same horizontal plane. The rollers 70 are followed by rollers 72. One pair of rollers 72 can be seen; a further pair is located perpendicularly in front of and behind the plane of FIG. 4, in the same horizontal plane. The rollers 72 are driven at a somewhat lower speed than the rollers 70, and the core 62 decreases in diameter in the direction from the rollers 70 to the rollers 72, such that between the two sets of rollers the paper tube 60 is crumpled longitudinally and radially imparting circumferential creases 74 to the paper tube 60. Pairs of rollers 80, 82, 84, 86, 88 that freely travel are disposed on the core 62 and serve to provide for low-friction travel along the paper tube 60 on the outside of the core 62. The resulting crumpled paper tube/paper cushion 90 thus has creases which are generally transverse to the longitudinal axis of the tube 60 and which extend circumferentially around the tube 60, and has a generally annular cross-section with an outer diameter and an inner diameter defining a longitudinal bore of the crumpled paper tube/paper cushion 90, and thereby has a resilience greater than that of the elongated paper tube 60 in an uncrumpled state.

The paper tube 60 can have perforation lines at uniform intervals along the length of the web of paper tube 60. Stopping rollers 70 at predetermined time intervals, which correspond to a particular length of paper cushion, while allowing rollers 72 to continue to rotate, will separate the leading paper cushion from the trailing paper cushion. Alternatively, the cushions can be separated manually, or a cutting device could be employed if the paper tube 60 is not perforated.

Additional details of the machine 20 and paper cushion 90 may be seen with reference to the assignee's U.S. Pat. Nos. 7,972,258, 8,114,490, and 8,491,453, which are hereby incorporated by reference herein as if fully set forth in their entirety.

Referring back to FIGS. 1-3, work surfaces 30, 40 can be work tables, for example. They could also be conveyors. Each has four supporting legs 92 and a lower shelf 94. The two legs 92 nearest the slide 50 have extensions 96 that support an upper shelf 98 that is centered over the slide 50. The slide 50 can be supported by the work tables 30, 40 and/or the legs 92, for example supported atop cross members 193 attached to legs 92. As cushions 90 are made by machine 20, the elongated slide 50, being positioned between the work tables 30, 40, receives and directs advancing cushions 90 from the machine 20 longitudinally along the work tables 30, 40 and transversely between the work tables 30, 40. The work station 10 advantageously permits a packer 100 to be positioned on each side of the machine 20 and to have equal access to cushions 90 advancing along the slide 50 for placement into box 19. The work tables 30, 40 can be any suitable length, but must have a transverse dimension (width) that does not prevent a packer 100 from reaching across the work table 30, 40 to remove a cushion 90 from the slide 50. For example, the work tables 30, 40 can be about twenty one inches wide and not prevent a packer 100 from reaching across the work table to remove a cushion 90 from the slide 50. Additional suitable dimensions for the work tables 30, 40 are about sixty inches long and about thirty five inches high; shelf 98 can be about eighteen inches wide at a height of about forty eight inches.

Referring to FIGS. 1-6, the slide 50 can be semi-circular 110, i.e. continuously open about 180 degrees from above along its length, or a little more than semi-circular, for example open about 120 degrees along its length, or tubular 120 with discrete openings 122 along its length. For the size of cushions 90 typically made by machine 20, an appropriate diameter for the slide 50 is about 6 to 9 inches. In addition, the slide 50 can include a plurality of photo eyes 130 positioned along its length. The photo eyes can be configured to communicate with the machine 20 via a controller 132 such that when uncovered, as by a packer 100 removing a cushion 90 from over a photo eye 130, the controller 132 commands the machine 20 to make more cushions 90 until the photo eye 130 is again covered with cushions 90.

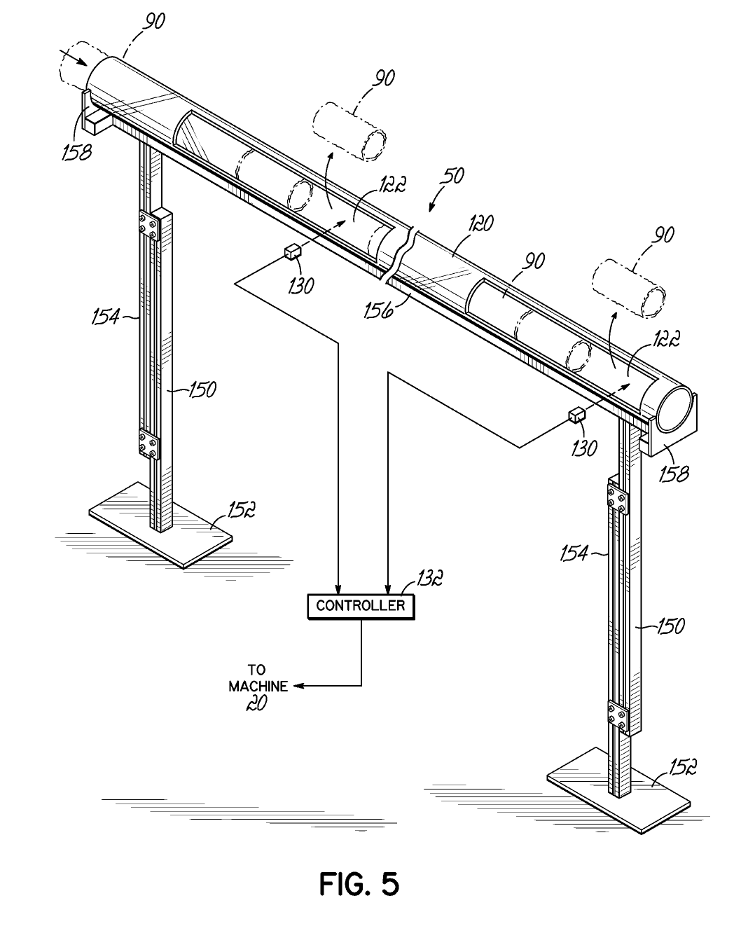

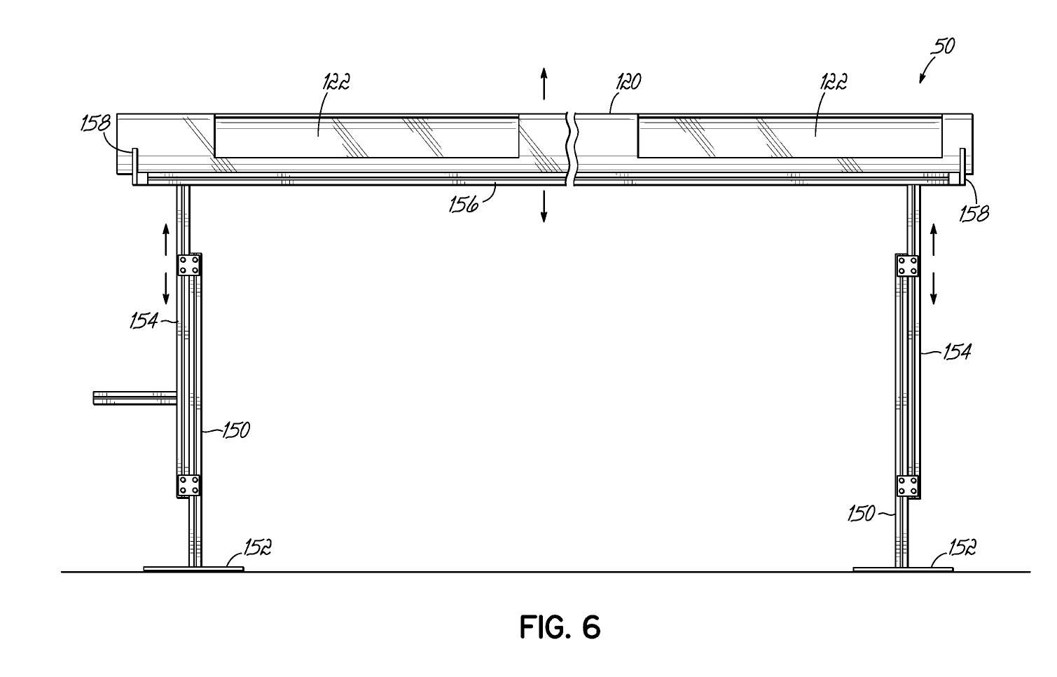

Referring to FIGS. 5 and 6, an alternative mounting arrangement of slide 50 is illustrated. Rather than being supported by the work tables 30, 40 and/or the legs 92, the slide 50 is free standing, having its own pair of lower legs 150 with bases 152, vertically adjustable upper legs 154, horizontal support 156, and end plates 158. This embodiment permits a packer to place a slide between two work tables, slide the work tables towards one another so as to be closely adjacent the slide, adjust the vertical height of the slide 50 via the adjustable upper legs 154 to the appropriate height, place a machine at the end of the slide 50, and commence packing operations.

The present invention provides a number of advantages. First, the cushion machine and packing table are combined into a work station with a single compact footprint. Second, the work station has a high degree of flexibility in that it can be accessorized by adding items such as computer monitors, keyboards, additional shelving, box dividers, etc. Third, the work station is easily modified to convert it from a double sided work table to a single sided work table. Fourth, the work station exhibits improved ergonomics/human factors, as packers will not have to move anywhere for packaging cushions since they will be right in front of the packers, nor will packers have to over extend or stretch to reach them. Fifth, the work station exhibits improved accessibility in that packers will be able to have their printers, tape guns, labels, etc. all right there on the work table keeping everything close for convenience.

The various embodiments of the invention shown and described are merely for illustrative purposes only, as the drawings and the description are not intended to restrict or limit in any way the scope of the claims. Those skilled in the art will appreciate various changes, modifications, and improvements which can be made to the invention without departing from the spirit or scope thereof. The invention in its broader aspects is therefore not limited to the specific details and representative apparatus and methods shown and described. Departures may therefore be made from such details without departing from the spirit or scope of the general inventive concept. The invention resides in each individual feature described herein, alone, and in all combinations of any and all of those features. Accordingly, the scope of the invention shall be limited only by the following claims and their equivalents.

What is claimed is:

1. A protective packaging work station comprising:
a first elongated work surface,
a second elongated work surface spaced transversely from said first elongated work surface,
a machine that makes protective packaging cushions positioned at corresponding ends of said work surfaces, and
an elongated slide positioned between said work surfaces that receives cushions from said machine and directs the cushions longitudinally along said work surfaces and transversely between said work surfaces as said machine makes and dispenses the cushions.

2. The work station of claim 1 wherein said machine is configured to make paper cushions.

3. The work station of claim 2 wherein said machine comprises:
a supply of an elongated web of paper tube,
a core,
a feed mechanism for feeding said paper tube over said core, and
a crumpling mechanism, downstream of said feed mechanism, for crumpling said paper tube around a circumference thereof.

4. The work station of claim 2 wherein said machine is configured to crumple an elongated paper tube longitudinally and radially so as to impart creases which are generally transverse to a longitudinal axis of the tube and which extend circumferentially around the tube, the crumpled paper tube having a generally annular cross-section with an outer diameter and an inner diameter defining a longitudinal bore of the crumpled paper tube, the crumpled paper tube having a resilience greater than that of the elongated paper tube in an uncrumpled state.

5. The work station of claim 1 wherein each of said work surfaces is a work table.

6. The work station of claim 5 further including a shelf positioned above said work tables and centered over said slide.

7. The work station of claim 5 further including a shelf positioned below each said work table.

8. The work station of claim 1 wherein said slide is continuously open from above along a length thereof.

9. The work station of claim 1 wherein said slide is a tube with discrete openings therein along a length thereof.

10. The work station of claim 1 further including a plurality of photo eyes positioned along said slide, said photo eyes configured to communicate with said machine such that when uncovered as by a packer removing a cushion from thereover, said photo eyes command said machine to make more cushions until covered again.

11. The work station of claim 1 wherein said slide is supported by said work surfaces.

12. The work station of claim 1 wherein said slide is free standing independent of said work surfaces.

13. The work station of claim 1 wherein each said work surface has a transverse dimension that does not prevent a packer from reaching across said work surface to remove a cushion from said slide.

14. A protective packaging work station comprising:
a first elongated work table supported by legs,
a second elongated work table supported by legs and spaced transversely from said first elongated work table,
a machine for making protective packaging cushions positioned at corresponding ends of said work tables and comprising a supply of an elongated web of paper tube, a core, a feed mechanism for feeding said paper tube over said core, and a crumpling mechanism, downstream of said feed mechanism, for crumpling said paper tube around a circumference thereof, and
an elongated slide supported by said work tables that receives cushions from said machine and directs the cushions longitudinally along said work tables and transversely between said work tables as said machine makes and dispenses the cushions.

15. The work station of claim 14 further including a controller and a plurality of photo eyes positioned along said slide, said photo eyes configured to communicate with said machine via said controller such that when uncovered as by a packer removing a cushion from thereover, said controller commands said machine to make more cushions until covered again.

16. A protective packaging work station comprising:
a first elongated work table supported by legs,
a second elongated work table supported by legs and spaced transversely from said first elongated work table,
a machine for making protective packaging cushions positioned at corresponding ends of said work tables and comprising a supply of an elongated web of paper tube, a core, a feed mechanism for feeding said paper tube over said core, and a crumpling mechanism, downstream of said feed mechanism, for crumpling said paper tube around a circumference thereof, and
an elongated and free standing slide positioned between said work tables that receives cushions from said machine and directs the cushions longitudinally along said work tables and transversely between said work tables as said machine makes and dispenses the cushions.

17. The work station of claim 16 wherein said slide is supported on a pair of vertically adjustable legs.

18. The work station of claim 16 further including a controller and a plurality of photo eyes positioned along said slide, said photo eyes configured to communicate with said machine via said controller such that when uncovered as by a packer removing a cushion from thereover, said controller commands said machine to make more cushions until covered again.
